(19) United States
(12) Patent Application Publication
(10) Pub. No.: US 2003/0069051 A1
(43) Pub. Date: Apr. 10, 2003

(54) Sensor with a wireless power supply and method for a wireless power supply

(76) Inventors: Philippe Pretre, Baden-Dattwil (CH); Guntram Scheible, Hirschberg (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/277,125

(22) Filed: Oct. 21, 2002

Related U.S. Application Data
(63) Continuation of application No. PCT/CH01/00241, filed on Apr. 17, 2001.

(30) Foreign Application Priority Data
Apr. 20, 2000 (DE) 100 19 539.3

(51) Int. Cl. H04B 1/16; H04M 1/00; H04B 1/38

(52) U.S. Cl. 455/572; 455/343

(57) ABSTRACT

A sensor with a wireless power supply includes, as a sensor unit, a resonant circuit having a capacitance and a coil, the coil being used not only for measurement but also for reception of electromagnetic waves for supplying power to the sensor. In a first preferred embodiment of the invention, the sensor has a filter for frequency separation of the sensor signal into a supply component and payload signal component. In such a case, the sensor can be supplied during a measurement. In a second preferred embodiment of the invention, the sensor has a changeover switch for time separation of the sensor signal into the supply component and the payload signal component. In such a case, the sensor is supplied on an alternating cycle with a measurement.

### CROSS-REFERENCE TO RELATED APPLICATION

This application is a continuation of copending International Application No. PCT/CH01/00241, filed Apr. 17, 2001, which designated the United States and was not published in English.

### BACKGROUND OF THE INVENTION

Field of the Invention

The invention relates to the field of sensor technology. It relates in particular to a sensor with a wireless power supply in which the sensor can be supplied with power by electromagnetic waves, and to a method for a wireless power supply for a sensor that has a sensor unit with a resonant circuit, also referred to as a tuned circuit or an oscillator circuit, including a capacitance and a coil.

Proximity sensors generally exist and are used in automation systems, manufacturing systems, and process systems. Proximity sensors allow measurement of liquid levels or positions of workpieces or machine parts. Proximity switches allow detection of the presence or absence of liquids, workpieces, or machine parts. To eliminate the wiring from proximity sensors, as is advantageous for a large number of proximity sensors, proximity sensors transmit their measurement data without using cables, by radio, and are supplied without using wires. A wireless supply is provided, for example, by rechargeable batteries or by radio, as described in German Published, Non-Prosecuted Patent Application DE 44 42 677 A1. In the case of a wireless power supply by radio, the sensor needs to have a receiving antenna and a circuit for receiving the supplying radio waves. These require space and increase the size of the area required by the sensor, in comparison to a sensor that is supplied through wires.

### SUMMARY OF THE INVENTION

It is accordingly an object of the invention to provide a sensor with a wireless power supply and a method for a wireless power supply that overcomes the hereinafore-mentioned disadvantages of the heretofore-known devices and methods of this general type and that allow the sensor to be configured such that as much space as possible is saved and such that the sensor is mechanically simple.

With the foregoing and other objects in view, there is provided, in accordance with the invention, a sensor, including a wireless power supply for receiving power through electromagnetic waves, a sensor unit having a resonant circuit for non-contacting measurement, the resonant circuit receiving the electromagnetic waves and forming a sensor signal, a separating unit connected to the sensor unit for receiving the sensor signal, the separating unit separating the sensor signal into a supply component and a payload signal component, and a supply circuit connected to the separating unit for supplying energy contained in the supply component to the separating unit.

The sensor according to the invention with a wireless power supply has, as the sensor unit, a resonant circuit including a capacitance and a coil, in which case the coil is used both for measurement and for receiving electromagnetic waves for supplying power to the sensor.

Consequently, no specific coil is required for receiving electromagnetic waves for supplying power to the sensor so that the sensor can be smaller and simpler.

In accordance with another feature of the invention, the sensor has a filter for frequency separation of a sensor signal into a supply component and a payload signal component. The sensor can, thus, be supplied even while a measurement is being taken. Preferably, the separating unit has a frequency separation filter separating the sensor signal into a first frequency component corresponding to the supply component and a second frequency component corresponding to the payload signal component.

In accordance with a further feature of the invention, the sensor has a changeover switch for time separation of the sensor signal into the supply component and the payload signal component. In such a case, the sensor is supplied or is used for measurement alternately. Preferably, the separating unit has a changeover switch time separating the sensor signal into the supply component and the payload signal component.

In accordance with an added feature of the invention, the separating unit has means for clocked switching the changeover switch.

In accordance with an additional feature of the invention, the separating unit has a clocked switch connected to the changeover switch and switching the changeover switch.

In accordance with yet another feature of the invention, the separating unit has means for analyzing the sensor signal and for switching the changeover switch dependent upon a result of an analysis of the sensor signal.

In accordance with yet a further feature of the invention, the separating unit has an analysis device analyzing the sensor signal and switching the changeover switch dependent upon a result of an analysis of the sensor signal.

In accordance with yet an added feature of the invention, the supply circuit has means for storing a portion of the energy contained in the supply component.

In accordance with yet an additional feature of the invention, the supply circuit has an energy storage device storing a portion of the energy contained in the supply component.

With the objects of the invention in view, there is also provided a wireless powered sensor supplied with power through electromagnetic waves, including a sensor unit having a resonant circuit for non-contacting measurement, the resonant circuit receiving the electromagnetic waves and forming a sensor signal, a separating unit connected to the sensor unit for receiving the sensor signal, the separating unit separating the sensor signal into a supply component and a payload signal component, and a supply circuit connected to the separating unit for supplying energy contained in the supply component to the separating unit.

With the objects of the invention in view, there is also provided a method for supplying wireless power to a sensor, including the steps of providing a sensor with a sensor unit having a resonant circuit including a capacitance and a coil, forming a measurement signal with the sensor unit, receiving, with the coil, electromagnetic waves for supplying power to the sensor and forming a supply signal with the coil, creating a sensor signal by superimposing the supply signal on the measurement signal, and separating the sensor signal into a payload signal component and a supply component with a separating unit.

In accordance with again another mode of the invention, the sensor signal is frequency separated with a filter into the payload signal component and the supply component.

In accordance with again a further mode of the invention, the separating unit frequency-separates the sensor signal with a filter into the payload signal component and the supply component.

In accordance with again an added mode of the invention, the sensor signal is time separated with a changeover switch into the payload signal component and the supply component.

In accordance with a concomitant mode of the invention, a changeover switch time-separates the sensor signal into the payload signal component and the supply component.

Other features that are considered as characteristic for the invention are set forth in the appended claims.

Although the invention is illustrated and described herein as embodied in a sensor with a wireless power supply, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block and schematic circuit diagram of a sensor according to the invention;

FIG. 2 is a block and schematic circuit diagram of a first embodiment of the sensor of FIG. 1;

FIG. 3 is a time graph of signal profiles for sensor of FIG. 2; and

FIG. 4 is a block and schematic circuit diagram of other embodiments of the sensor of FIG. 1.

### DESCRIPTION OF THE PREFERRED EMBODIMENTS

In the figures of the drawings, unless stated otherwise, identical reference symbols denote identical parts.

### APPROACHES TO IMPLEMENTATION OF THE INVENTION

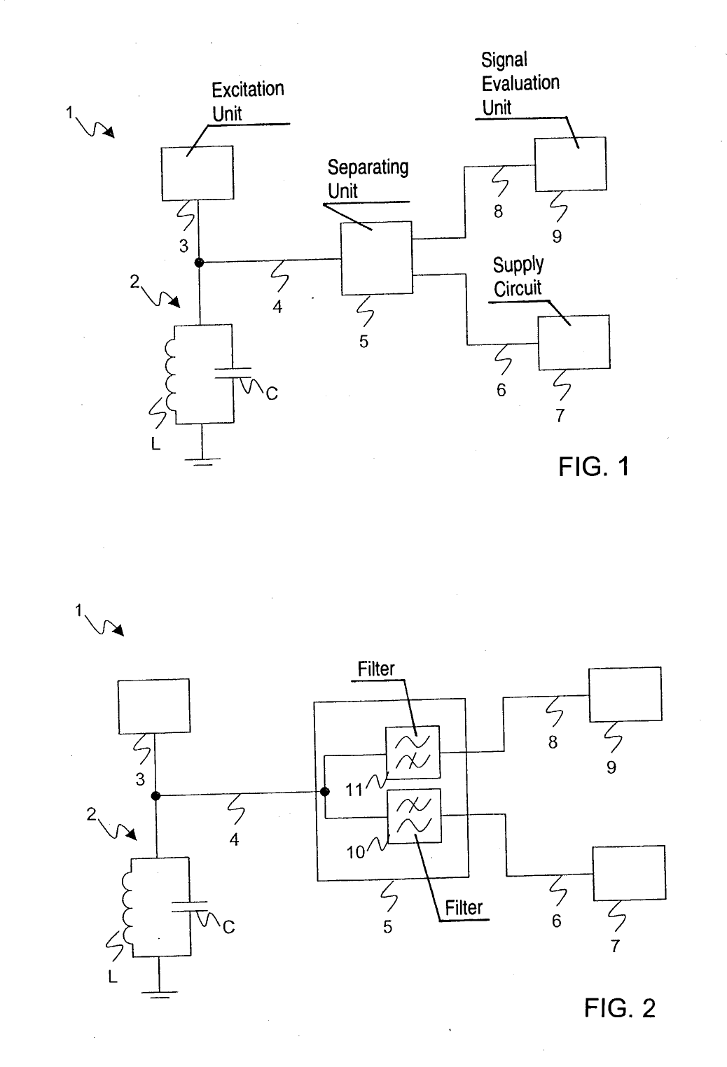

Referring now to the figures of the drawings in detail and first, particularly to FIG. 1 thereof, there is shown, schematically, a sensor 1 according to the invention. The sensor 1 has a sensor unit 2, an excitation unit 3, a separating unit 5, a supply circuit 7 and a signal evaluation unit 9. The sensor unit 2 is used for producing a sensor signal 4. The excitation unit 3 is used for exciting the sensor unit 2. The separating unit 5 is used for separating the sensor signal 4 into a supply component 6 and a payload signal component 8. The supply circuit 7 is used for drawing power from the supply section 6 and for supplying the sensor 1 with power. The signal evaluation unit 9 is used for determining a data signal based on the payload signal component 8.

The sensor unit 2 has a resonant circuit L, C with a coil L and a capacitance C. It operates in a conventional manner as an inductive proximity sensor for a non-contacting, measurement. For such a purpose, the resonant circuit is stimulated to oscillate by the excitation unit 3. If a metallic object is located in the area of influence of the coil L, the amplitude and the frequency of the oscillation are changed based upon the distance to and the material of the object. Such a change in the oscillation is used as a measurement signal for determining the presence of an object, or the distance to an object.

In another embodiment of the invention, the sensor unit 2 operates as a capacitive proximity sensor. In such a case, the resonant circuit oscillates only when a target object is located in the area of influence of the sensor.

According to the invention, the coil L is also used as a “pick-up” coil for receiving electromagnetic waves from a supply field that are transmitted by a transmitter to supply one or more sensors 1. The supply field induces a voltage or a supply signal in the coil L. Such a voltage, or the supply signal, is superimposed on the measurement signal. The superimposition results in the sensor signal 4. One resonant frequency of the resonant circuit L, C is, preferably, tuned to maximum measurement sensitivity.

The separator unit 5 separates the sensor signal 4 into the supply component 6 and the payload signal component 8. The payload signal component 8 corresponds substantially to the measurement signal. The supply component 6 corresponds substantially to the supply signal that is produced by the received electromagnetic waves.

The payload signal component 8 is evaluated in a conventional manner by the signal evaluation unit 9. The signal evaluation unit 9 uses the payload signal component 8 to produce a data signal that, for example, represents the presence of or the distance to an object. The data signal is, preferably, transmitted without wires to a base station, and is used for controlling a machine or system. A machine or system such as this is, for example, a robot, an automatic assembly machine, a numerically controlled machine tool, or a part of a manufacturing cell, an industrial production facility, or a process system.

The supply component 6 is passed to the supply circuit 7, which draws energy from the supply component 6 and uses the energy to supply the sensor 1, or as a power supply for the sensor 1. The supply circuit 7, preferably, has measures for storage of the energy that is taken from the supply component 6, for example, a rechargeable battery or a capacitance with a corresponding charging circuit.

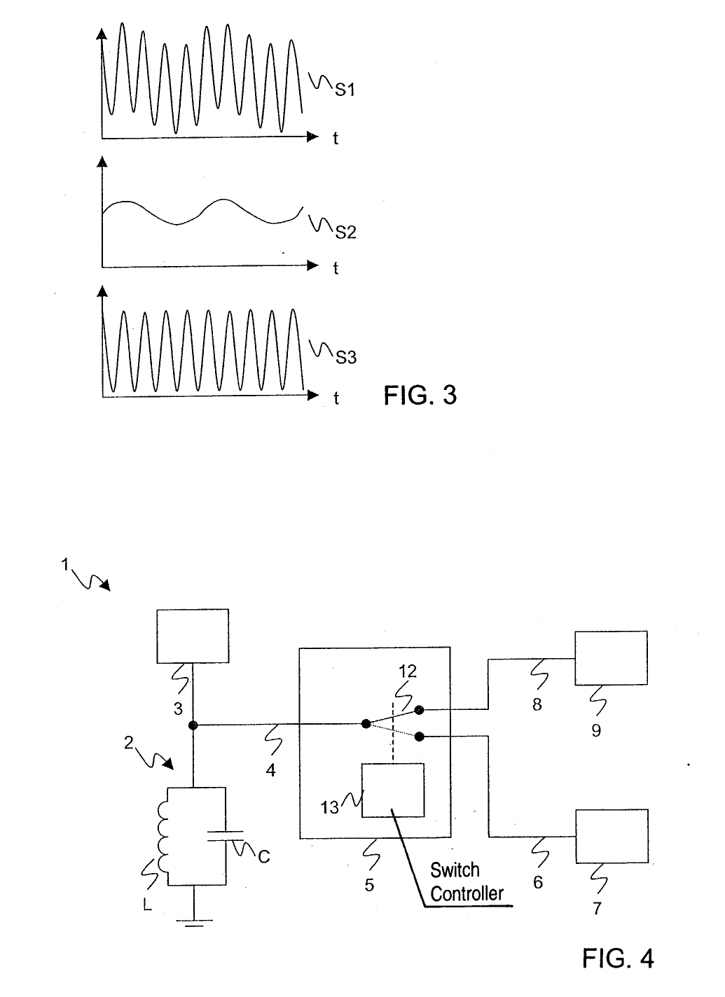

FIG. 2 shows, schematically, a first preferred embodiment of the invention. The excitation unit 3 and the transmitter that is used for supply purposes operate, in the first embodiment, at different frequencies, that is to say, a measurement frequency of the excitation unit 3 and a supply frequency for the supply field are different. The separating unit 5 has filters 10, 11 for frequency separation of the sensor signal 4 into a first frequency component and a second frequency component. In such a case, the first frequency component, which is in a first frequency band, corresponds to the supply component 6, and the second frequency component, which is in a second frequency band, corresponds to the payload signal component 8. Preferably, a lower frequency is used for the supply than for the measurement frequency. The supply component 6 is obtained by a first filter 10, for example, a low-pass filter. The payload signal component 8 is obtained by a second filter 11, for example, a high-pass filter. FIG. 3 shows, for such a situation, a signal profile S1 of a corresponding sensor signal 4, a signal profile S2 of a supply component 6, and a signal profile S3 of a payload signal component 8, respectively plotted along a time axis t.

In one preferred embodiment of the invention, the supply frequency is approximately 100 kHz, and the measurement frequency is approximately 1 MHz. The amplitude of the payload signal component is approximately twice as great as the amplitude of the supply component. The amplitude of the payload signal component is approximately 1 volt.

FIG. 4 shows, schematically, a second and third preferred embodiment of the invention. In FIG. 4, the separating unit 5 has a changeover switch 12 for time separation of the sensor signal 4 into the supply component 6 and the payload signal component 8. The changeover switch 12 passes the sensor signal 4 alternately to the signal evaluation unit 9 or to the supply circuit 7. A switch controller 13 controls the changeover switch 12.

In the second embodiment of the invention, the switch controller 13 has measures for clocked switching, for example, a clock. The time intervals in which the sensor signal 4 is passed to the signal evaluation unit 9 or to the supply circuit 7 each have a predetermined, constant length. The excitation unit 3 and/or the transmitter that is used for the supply are, likewise, correspondingly clocked and are operated in synchronism with the switching in the sensor 1 so that a measurement signal and a supply signal are produced alternately. The synchronization is carried out, for example, by a synchronization bit pattern that is transmitted without using wires.

Preferably, a measurement is carried out for approximately 100 microseconds in each millisecond, with the supply being provided for approximately 500 microseconds in each millisecond.

In the second exemplary embodiment of the invention, the measurement frequency and the supply frequency are either approximately the same or differ from one another.

In the third embodiment of the invention, the switching is controlled by analysis of the sensor signal 4. The measurement frequency and the supply frequency in such a case, preferably, differ from one another. The switch controller 13 has measures for analysis of the sensor signal 4 and for switching of the changeover switch 12 based upon a result of the analysis. For example, a detector detects the presence of a supply signal and, then, switches the sensor signal 4 to the supply circuit 7. Otherwise, the sensor signal 4 is switched to the signal evaluation unit 9. Preferably, the supply is provided during pauses in operation of the sensor 1 or of the system or machine. Such a pause in operation lasts from a few seconds up to several hours, depending on the nature of the system or machine.

In a further embodiment of the invention, the proximity sensor is a proximity switch, which has only binary switching states.

The sensor according to the invention does not require a separate supply coil for the wireless supply so that it is configured to be smaller and mechanically simpler. An additional electronic circuit for the separating unit can be fitted on an existing board, which is physically simpler than installation of a supply coil.

We claim:

1. A sensor, comprising:
a wireless power supply for receiving power through electromagnetic waves;
a sensor unit having a resonant circuit for non-contacting measurement, said resonant circuit receiving the electromagnetic waves and forming a sensor signal;
a separating unit connected to said sensor unit for receiving the sensor signal, said separating unit separating the sensor signal into a supply component and a payload signal component; and
a supply circuit connected to said separating unit for supplying energy contained in the supply component to said separating unit.

2. The sensor according to claim 1, wherein said separating unit has a frequency separation filter separating the sensor signal into:
a first frequency component corresponding to the supply component; and
a second frequency component corresponding to the payload signal component.

3. The sensor according to claim 1, wherein said separating unit has a changeover switch time separating the sensor signal into the supply component and the payload signal component.

4. The sensor according to claim 3, wherein said separating unit has means for clocked switching said changeover switch.

5. The sensor according to claim 3, wherein said separating unit has a clocked switch connected to said changeover switch and switching said changeover switch.

6. The sensor according to claim 3, wherein said separating unit has means for analyzing the sensor signal and for switching said changeover switch dependent upon a result of an analysis of the sensor signal.

7. The sensor according to claim 3, wherein said separating unit has an analysis device analyzing the sensor signal and switching said changeover switch dependent upon a result of an analysis of the sensor signal.

8. The sensor according to claim 1, wherein said supply circuit has means for storing a portion of the energy contained in the supply component.

9. The sensor according to claim 1, wherein said supply circuit has an energy storage device storing a portion of the energy contained in the supply component.

10. A wireless powered sensor supplied with power through electromagnetic waves, comprising:
a sensor unit having a resonant circuit for non-contacting measurement, said resonant circuit receiving the electromagnetic waves and forming a sensor signal;
a separating unit connected to said sensor unit for receiving the sensor signal, said separating unit separating the sensor signal into a supply component and a payload signal component; and
a supply circuit connected to said separating unit for supplying energy contained in the supply component to said separating unit.

11. A method for supplying wireless power to a sensor, which comprises:
providing a sensor with a sensor unit having a resonant circuit including a capacitance and a coil;
forming a measurement signal with the sensor unit;
receiving, with the coil, electromagnetic waves for supplying power to the sensor and forming a supply signal with the coil;
creating a sensor signal by superimposing the supply signal on the measurement signal; and
separating the sensor signal into a payload signal component and a supply component with a separating unit.

12. The method according to claim 11, which further comprises frequency separating the sensor signal with a filter into the payload signal component and the supply component.

13. The method according to claim 11, wherein the separating unit frequency-separates the sensor signal with a filter into the payload signal component and the supply component.

14. The method according to claim 11, which further comprises time separating the sensor signal with a changeover switch into the payload signal component and the supply component.

15. The method according to claim 11, wherein a changeover switch time-separates the sensor signal into the payload signal component and the supply component.
